(19) United States
(12) Patent Application Publication
(10) Pub. No.: US 2016/0048793 A1
(43) Pub. Date: Feb. 18, 2016

(54) Microjob Rating And Payment System

(71) Applicant: Lisa Ann Lamb, Atlanta, GA (US)

(72) Inventor: Lisa Ann Lamb, Atlanta, GA (US)

(21) Appl. No.: 14/827,303

(22) Filed: Aug. 15, 2015

Related U.S. Application Data
(60) Provisional application No. 62/038,326, filed on Aug. 17, 2014.

(51) Int. Cl. G06Q 10/06

(52) U.S. Cl. CPC G06Q 10/06393

(57) ABSTRACT

A system and method in which a rating or feedback based system is used on a web or mobile based application for a microjob, also known as a small task, gig, freelance job or microwork. The rating or feedback based system is used to determine either qualification for a microjob, payment for a microjob, or both. The rating or feedback based system is funded by direct deposits or a subscription service.

### CROSS-REFERENCE TO RELATED APPLICATIONS

This application claims the benefit of U.S. Provisional Application No. 62/038,326, filed Aug. 17, 2014, the disclosure of which is incorporated herein by reference.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISC APPENDIX

Not applicable.

### BACKGROUND OF THE INVENTION

1. Technical Field

This invention relates generally to the field of computer technology and, in a specific example embodiment, to a system and method of payment for a microjob based rating system.

2. Related Art

There are a number of microjob based web applications in existence. A “microjob”, or “small task”, or “gig” is a small job completed by a user as an independent contractor of the hiring user for payment.

The problems that exist in the related art of microjob based web applications are fixed payment amounts not related to performance or the scope of work, competition and limited microjobs that can be completed by the general public with minimal skill.

Microjob based web applications generally list a fixed amount of five dollars, ten dollars or amounts based on those increments for the user, most likely a freelancer or entrepreneur to complete. The freelancer or entrepreneur determines the task to be completed and another user selects them to complete the microjob. Because the freelancer or entrepreneur lists the microjob, this eliminates the general public from using the site since they have no service to offer.

Microjob based web applications generally list numerous freelancers and entrepreneurs that perform the same microjob. This creates a high level of competition and most microjob providers will never receive payment. Because microjobs are also being offered for a fixed amount there is a low quality level of microjob completion.

### BRIEF SUMMARY OF THE INVENTION

The microjob rating and payment system is a rating system that is used to rank a user based on the amount of microjobs completed. The rating system starts at a specified amount and a payment amount is attached to each level. All users start at the same rating and payment amount unless the rating is raised by the administrator of the system in special cases.

The microjob rating and payment system reverses the roles of the microjob seeker and the hirer as the hirer sets the rating, and thus the payment amount for each microjob. This solves both the problem of a fixed amount that limits the hirer, and the microjob seeker not being qualified for the scope of work.

The microjob rating and payment system starts at a minimal amount which allows a hirer to list a microjob for minor small tasks like a website or video review. This allows the general public with little or no skills to complete microjobs, unlike the related art microjob applications that are freelancer and entrepreneur based.

The microjob rating and payment system reverses the roles of the microjob seeker and hirer and allows the hirer to have multiple microjob seekers completing the tasks at once, thus eliminating the problem of competition in related art microjob applications.

The microjob rating and payment system is not based on a fixed payment amount system and allows the hirer to use a subscription based method of payment.

The object of the microjob rating and payment system is to provide a system and method of payment for a microjob not based on a fixed amount; to provide a system and method of microjob payment based on a rating or feedback based system; to eliminate competitiveness in finding a microjob; to provide a system and method to make microjobs available to the general public to complete with little to no skill, and to provide a system and method where a subscription service can be used to pay for microjobs.

### BRIEF DESCRIPTION OF THE DRAWINGS

FIG. 1 is a diagram depicting the steps in the microjob rating and payment system as in the web application.

FIG. 2 is the same as FIG. 1 with the end user steps highlighted that depict the initial rating stage when the user registers and when the microjob rating and payment system raises the rating and the user is paid.

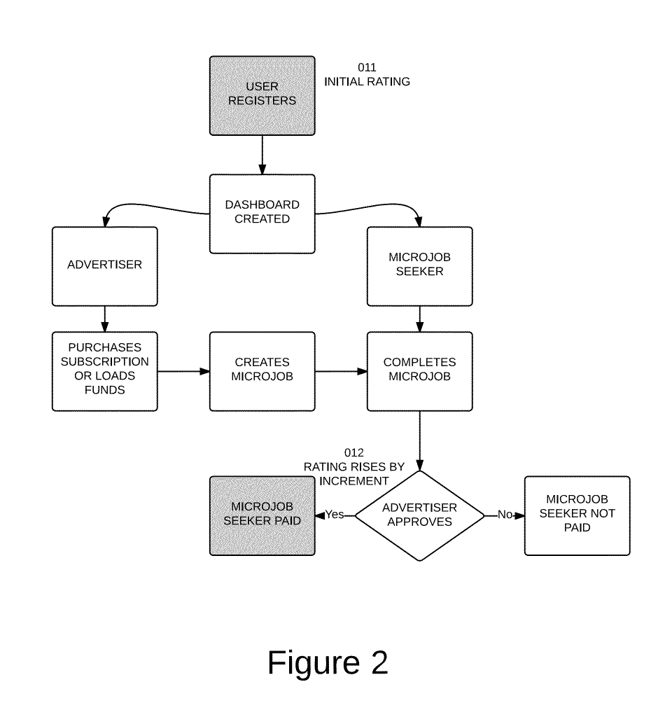

FIG. 3 is an example of the microjob rating and payment system depicting the process in which the user (as an advertiser) uses the microjob rating and payment system to select the rating ranges and payment amount for each microjob. The amounts are for example purposes only and can be modified in the microjob rating system. It also depicts the user (as a microjob seeker) accepting the microjob based on their rating and submitting it for approval or rejection.

### DETAILED DESCRIPTION OF THE INVENTION

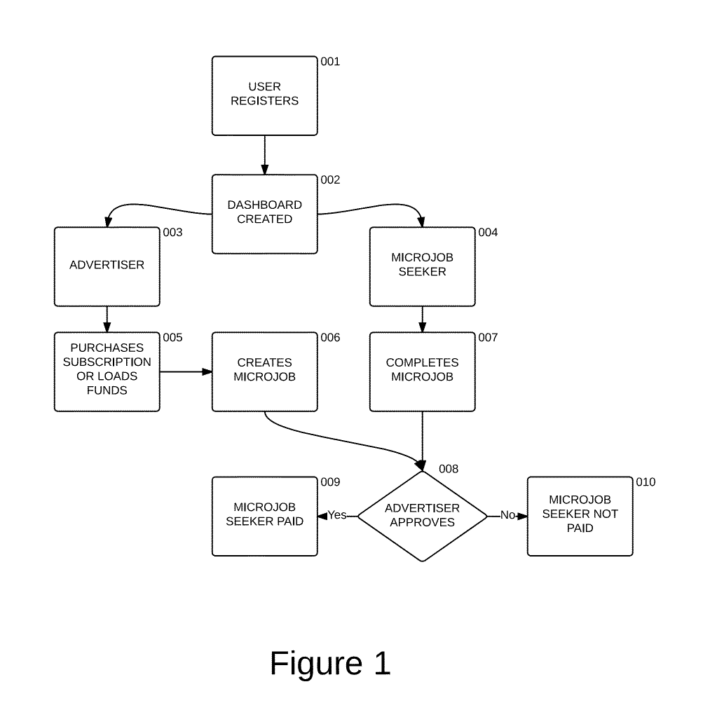

The user registers on either a web based application or mobile device (FIG. 1, 001).

An account dashboard (FIG. 1, 002) is created for user as either advertiser (FIG. 1, 003) or microjob seeker (FIG. 1, 004), or both may be combined into one dashboard.

An advertiser loads funds, (money, coins or credits), into their account by direct deposit or purchasing a subscription (FIG. 1, 005). No other microjob based web or mobile application allows a user to purchase a subscription for hiring for microjobs.

An advertiser creates a microjob campaign by using the funds in their account (FIG. 1, 006) by setting the rating range of payment for the microjob seeker. No other microjob based web or mobile application allows a user to hire a pay another user by using a rating or feedback based system.

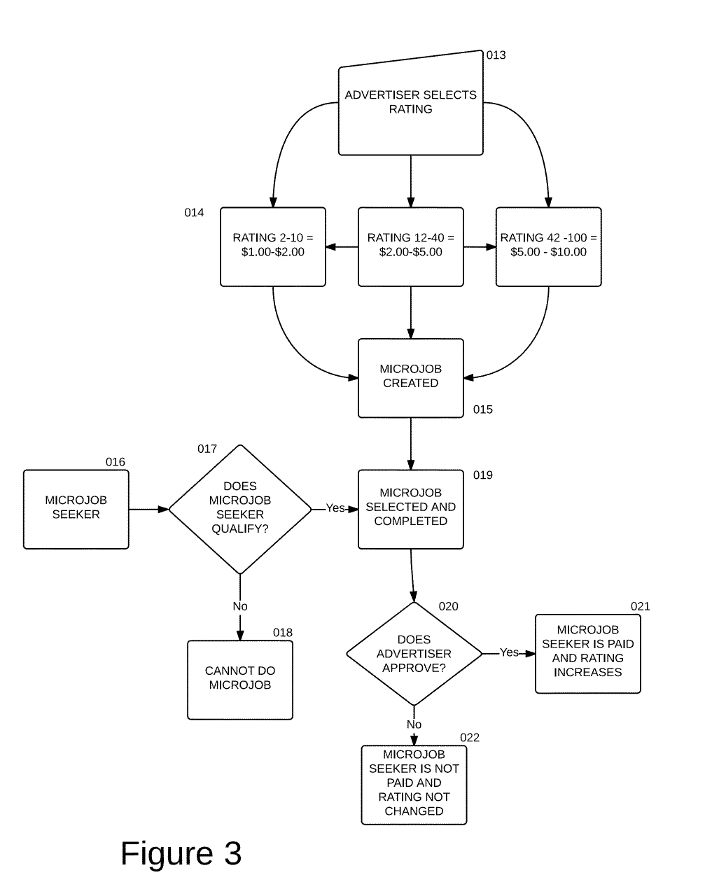

The rating selection for the advertiser is illustrated by example (FIGS. 3, 013 and 014)

The microjob is created and microjob seekers apply for the microjob. If the microjob seekers rating is within the specified rating range by the advertiser then the microjob seeker is qualified (FIG. 3, 017), and can complete the microjob. If the microjob seeker is not within the range that is specified by the advertiser they are not qualified and cannot complete the microjob (FIG. 3, 018).

The microjob seeker completes the microjob and submits it for approval or rejection to the advertiser (FIGS. 3, 019 and 020).

The advertiser approves the microjob and the microjob seeker is paid and their rating is increased (FIG. 3, 021), or the advertiser rejects the microjob and the microjob seeker is not paid and their rating is not changed.

1. A system or method in which a rating or feedback based system is used to determine qualification for completing of a microjob, also known as a small task, microwork, freelance work or gig.

2. A system or method in which a rating or feedback based system is used to determine payment for completing of a microjob, also known as a small task, microwork, freelance work or gig.

3. A system or method in which a subscription service is used to accept payment for creation for a microjob campaign or for paying for a microjob, also known as a small task, microwork, freelance work or gig.
